(19) United States
(12) Patent Application Publication
(10) Pub. No.: US 2014/0136497 A1
(43) Pub. Date: May 15, 2014

(54) System And Method To Compare And Merge Documents

(71) Applicant: PERFORCE SOFTWARE, INC., Alameda, CA (US)

(72) Inventors: Georgi A. Georgiev, Walnut Creek, CA (US); Wayne A. Christopher, Berkeley, CA (US)

(73) Assignee: Perforce Software, Inc., Alameda, CA (US)

(21) Appl. No.: 13/843,234

(22) Filed: Mar. 15, 2013

Related U.S. Application Data
(60) Provisional application No. 61/725,988, filed on Nov. 13, 2012.

(51) Int. Cl. G06F 17/30

(52) U.S. Cl. CPC G06F 17/3023
USPC 707/695

(57) ABSTRACT

A system to compare and merge a plurality of documents is described. The system includes a data format module configured to determine format of documents and data structures in the documents. The system also includes an abstract description module configured to receive determined data structures and configured to generate a merge case. Further, the system includes a merge module configured to receive determined data structures and configured to generate a merged data structure. And, the system includes a pack module configured to receive the merged data structure and to generate a merged document based on at least said merged data structure.

### CROSS-REFERENCE TO RELATED APPLICATIONS

This application claims priority from U.S. Provisional Patent Application No. 61/725,988, filed on Nov. 13, 2012 and is hereby incorporated by reference in its entirety.

### FIELD

Embodiments of the invention relate to a document revision control system. In particular, embodiments of the invention relate to a system to compare and merge multiple versions of documents.

### BACKGROUND

The ability to create electronic documents provides the ability to share the documents among many people. This provides the ability to collaborate on the electronic document in parallel. The ability to collaborate on the electronic document in parallel results in multiple versions of the original document. This creates the problem of managing the changes made in parallel in order to maintain a common version of the document. Systems and methods exist to track revisions in a document by embedding information into the document each time a change is made. Such a system can be used to create a single document that incorporates the changes. These systems and methods require preserving additional information into the documents that is usually proprietary and therefore specific to that system or method. Other systems and methods used to compare and merge multiple versions of documents require completely transforming each document from its original format into a new format to compare and merge the documents. These systems compare and merge the changes between the documents using an algorithm tailored to determine any changes and merge any changes between the documents in the new format. The system must then convert the result with the merged changes back in to the original format. Such a system and method results in data loss as a result of changing the format of the document which results in an incomplete final document that does not fully reflect the data represented in the original versions.

### SUMMARY

A system to compare and merge a plurality of documents is described. The system includes a data format module configured to determine format of documents and data structures in the documents. The system also includes an abstract description module configured to receive determined data structures and configured to generate a merge case. Further, the system includes a merge module configured to receive determined data structures and configured to generate a merged data structure. And, the system includes a pack module configured to receive the merged data structure and to generate a merged document based on at least said merged data structure.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of an embodiment of a system to compare and merge documents;

FIG. 2 illustrates a block diagram of a distributed system according to an embodiment;

FIG. 3 illustrates a flow diagram for comparing and merging documents according to an embodiment;

FIG. 4 illustrates a flow diagram for generating a merge document based on a document including formatted text according to an embodiment;

FIG. 5 illustrates a per-paragraph data structure according to an embodiment;

FIG. 6 illustrates an itemized passage according to an embodiment;

FIG. 7 illustrates a result generated by merging text of corresponding itemized passages from related documents according to an embodiment;

FIG. 8 illustrates a result generated by merging text and formatting styles from related documents according to an embodiment; and

FIG. 9 illustrates a block diagram of a system according to an embodiment.

### DETAILED DESCRIPTION

Embodiments of a system and methods to compare multiple versions of documents are described. The system merges two or more versions of a document using a top to bottom approach by attempting to use the top level data structure of the original document before breaking the documents down to the next level data structure. This provides the benefit of maintaining the data of the original document when possible. This prevents data loss and provides the ability to use similar methods and techniques across multiple formats of documents.

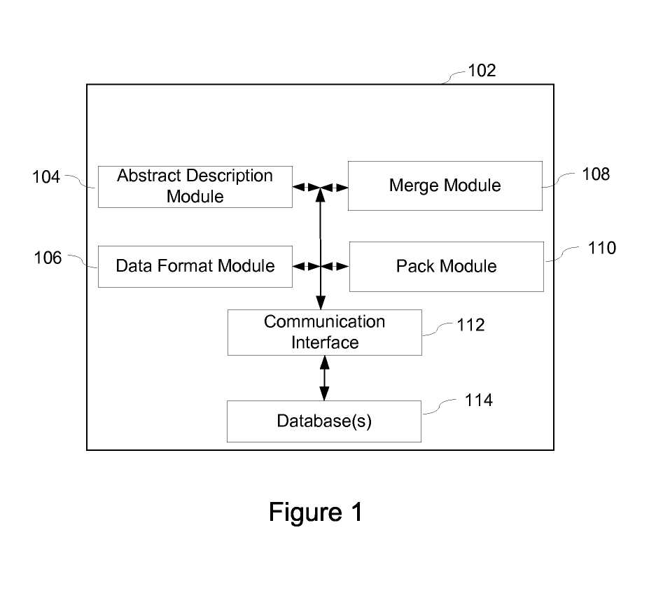

FIG. 1 illustrates a block diagram of an embodiment of a system to compare and merge documents. For an embodiment system 102 may be a computer, a server, a tablet, a smart phone, a user device or other device configured to comparing and merging multiple versions of a base document. The embodiment illustrated in FIG. 1 includes an abstract description module 104. For an embodiment, the abstract description module 104 is coupled with a merge module 106. The abstract description module 104, according to an embodiment, is configured to generate merge cases to provide to the data format module 106 based on a determined data structure included in a document.

For an embodiment merge cases include, but are not limited to, one or more of a policy, a definition, a condition, a technique, and a method used to compare a particular type of data structure that could be present in a document for comparing. Types of merge cases include, but are not limited to, blob, dictionary, set, group, sequence, and other methods to compare information organized in a type of data structure. A blob merge case may be used for analyzing a data structure at an agnostic level based on the presentation format (e.g., binary, extensible markup language (“XML”), java script object notation (“JSON”) or other format of arranging data). That is, analyzing a construction of the presentation format (e.g., bits, XML elements and attributes, and other elements, objects, or components that make up a presentation format) to determine a change between data structures. Thus, a blob merge case would involve comparing two or more data structures at the agnostic level based on a presentation format to determine any changes between the two or more data structures.

A dictionary merge case may be used for analyzing two or more data structures based on an arbitrary unique key of a data structure. That is, the dictionary merge case may be used to determine any changes between two or more data structures based on an arbitrary unique key of the data structure. An example of an arbitrary key includes, but is not limited to, a key that represents a file in a directory such as a file name. A set merge case may be used for analyzing two or more data structures based on content in the data structures. That is the set merge case may be used to determine any changes based on content in the data structures. A group merge case may be used for analyzing two or more data structures based on content in the data structures. That is, the group merge case may be used to determine any changes based on content in the data structures. A sequence merge case may be used for analyzing two or more data structures based on content in the data structures and its position in the sequence. That is, the sequence merge case may be used to determine one or more changes based on content in the data structures and its position in the sequence. One skilled in the art would understand that other cases may be used to analyze two or more data structures to determine any changes between the data structures based on knowledge of how the data structure is formed.

The embodiment of the system illustrated in FIG. 1 also includes a data format module 106 coupled with a communication interface 112 and a merge module 108. For an embodiment a data format module 106 is configured to receive one or more documents from a communication interface module 112. The data format module 106 determines the format of one or more documents such as those received from a communication interface module 112. For an embodiment, data format module 106 may determine a document format from the file name. One such embodiment of the data format module 106 determines a document format based on a file extension. A file extension may include, but is not limited to, doc, docx, xls, xlsx, pps, ppt, pptx, sdd, shw, pdf, html, xhtml, mhtml, mht, xht, htm, dot, dotx, odt, ott, pdax, rtf, wpd, wpt, wrd, wri, xhtml, xml, ods, ots, wk1, wk3, wk4, wks, wq1, xlsb, xlsm, xlsb, xltm, xlw, and other designations indicating a format of a document.

For another embodiment, data format module 106 is configured to parse a document to determine a format of the document based on information contained inside the document. One such embodiment includes analyzing a document to determine the format of a document based on one or more of data structures in the document, formatting information in the document, hierarchy of data structures, and other information in a document that would indicate a format of a document. A data structure includes, but is not limited to, a binaryblob, an xmlblob, a consolidation set, a pile set, keywords set, a sequence, a matrix, plain text, multilayer text, and other objects or elements that define how a data is arranged inside a document. A binaryblob data structure represents a content agnostic chunk of data including, but not limited to images and other binary data of an unknown format. An xmlblob data structure represents a content agnostic xml structure data that is organized as an extensible markup language (“XML”). A reference data structure includes data or an item that contains or otherwise points to another item in the document. A consolidation set data structure represents a collection of data objects that are merged as a unique union of items. A pile set data structure represents a collection of data objects that are merged as union of objects. A keywords set is a data structure that is merged as a union of items where the order is preserved as much as possible. A sequence data structure is a data structure that is merged as an ordered collection of items.

For an embodiment, a data format module 106 is configured to determine a reference data structure and to determine the relationship between the data structures or objects. In response to the determination of the relationship, the data format module 106 generates a data structure that incorporates the reference data structure with the one or more data structures or objects it references. For another embodiment, a data format module 106 generates one or more of a policy, a rule, a constraint, a definition, or a method to instruct a merge module 108 how to merge a reference data structure and its corresponding data structure or object. According to an embodiment, a data format module 106 is configured to analyze a reference data structure by determining data or an item that is a target of the reference or link included in the data structure. Once a data format module 106 determines the target of the reference or link, the target is merged before the data or item that references the target.

A vector data structure represents a data structure in a one dimensional collection of data such as data used to represent one or more paragraphs in a section of a document. A matrix data structure represents a data structure in a two dimensional collection of data such as data used to represent table cells. A plain text data structure includes a collection of data such as alphanumeric symbols. A multilayer text data structure includes a collection of data, such as alphanumeric symbols, with applied formatting or other markup. One skilled in the art would understand that other data structures can be defined to represent other formats for arranging data. Thus, embodiments are not limited to those data structures discussed above.

For an embodiment a document may be formed of one or more data structures. Some data structures may be formed of one or more data structures such that a top level data structure may include one or more lower level data structures. According to an embodiment, a data format module 106 is configured to analyze a document to determine a first data structure included in a base document and any related versions of the base document. The data format module 106 is configured to provide the first data structure type to a merge module 108 according to an embodiment. For an embodiment, a data format module 106 is configured to provide the first data structure type to an abstract description module 104. An abstract description module 104, according to an embodiment, in response receiving the first data structure type from data format module 106, is configured to determine a merge case for the data structure. An abstract description module 104, for an embodiment, is configured to provide the merge case to a merge module 108.

According to the embodiment of the system illustrated in FIG. 1, a data format module 106 is coupled with a merge module 108. A merge module 108, according to an embodiment, is configured to receive a data format for a received document from data format module 106. In response to receiving a data format type, merge module 108 is configured to request one or more merge cases from abstract description module 104 according to an embodiment. For another embodiment, abstract description module 104 is configured to receive a data structure type from data format module 106 and in response the abstract description module is configured to provide one or more merge cases to merge module 108.

For an embodiment, a merge module 108 is configured to analyze the first data structure of a base document and one or more versions of the base document to determine any changes between the first set of data structures of the documents based on one or more merge cases received from the abstract description module 104. For an embodiment, the merge module 108 compares the data in the data structures as defined in the one or more merge cases. Such compare techniques include, but are not limited to, comparing bit by bit, comparing extensible markup language elements, comparing caseless text or case-sensitive text, using a hash of the data structures to determine differences, or other techniques know in the art to compare one or more types, structures, or formats of data.

A merge module 108 is further configured according to an embodiment to merge any changes between a first data structure of the base and the one or more versions of the base document into a single data structure to generate a merged data structure to represent all changes between the data structures analyzed. For example, a merge module 108 may append the data structure in the base document with the new data found in the data structure in one or more versions of the base document. Another example includes a merge module 108 configured to merge the changes between the data structure of the base and the one or more versions of the base document by deleting data from the base document based on a determined change between the data structures. Yet another example includes merge module 108 configured to merge the changes between the data structures by replacing the data structure with one of the data structures from one or more versions of the base document to generate a merged data structure.

A merge module 108 may also determine no change occurred between a data structure of the base document and a corresponding data structure from the one or more versions of the base document. Thus, the merged data structure will be selected from any of the data structures that the merge module 108 compared. For an embodiment, the merge module 108 will keep the merged data structure in the base document to form a merged document that represents all changes across the different versions.

For an embodiment, a merge module 108 is configured to determine if a collision exists between the data structures analyzed. A collision is a case where all or part of a data structure being examined or analyzed is found to be different in content or existence any of the versions of the document. Embodiments include a merge module 108 configured to handle a collision at least one of several ways. A first way includes a merge module 108 configured to determine that a collision may be resolved without the need for further explanation or input based on the type of the data structure. For example, a merge module 108 may be configured to merge a dictionary data structure or a sequence data structure if the changes in the versions are determined to be in non-overlapping areas of the data structure. A second way includes a merge module 108 configured to request that a colliding part of the data structure resulting in the collision be further analyzed by a data format module 106 be explained or to determine a format of the colliding part, for example a data format module 106 may be configured to provide type or format information of the colliding parts of the data structure in response to a request from a merge module 108.

Once the merge module 108 receives further information from the data format module 106 and/or an abstract description module 104, the merge module 108 is configured to merge the colliding part of the data structures based on the information received. Thus, the resulting merged part is included in the merged data structure. A third way includes a merge module 108 configured to merge the colliding data structures based on a policy to resolve collisions of the type found, including, but not limited to, a policy to select a later version of a base document over an earlier version or the base document. A merged module 108 using a policy provides the merged module 108 to generate a merged data structure without requesting the data format module 106 to further explain or analyze the data structures. The fourth way includes a merge module 108 configured to determine how to resolve the collision by requesting user input. For example, a merge module is configured to request input, or may be configured to include one or more possible solutions in the merged document with an indication that a collision should be manually resolved. A fifth way includes a merge module 108 configured to report a collision as a conflict based on a type of data structured or format of the documents being analyzed.

For an embodiment, when a collision occurs, a merge module is configured to request updated merge cases, definitions, or policies from an abstract description module 104. In response, the abstract description module is configured to provide updated merge cases, definitions, or policies based on the type of conflict indicated by merge module 108. When a merge module 108 determines that a conflict occurs based on the analyzed data structures including one or more other data structures, the merge module 108 is configured to send a request to data format module 106 to further explain or provide addition information on the data structures contained in the data structure being analyzed.

According to an embodiment, data format module 106 is configured to determine the next level data structure included in the data structure being analyzed. Upon determination of the type of the next level data structure, the data format module 106 is configured to provide the type information to an abstract description module 104, a merge module 104, or both as discussed for embodiments described herein. The abstract description module 104 is configured to provide another merge case based on receiving type information of the next level data structure included in the data structure being analyzed to the merged module 108. For another embodiment, a data format module 106 is configured to parse the next level data structure to put the data structure in another format for the merge module 108. Examples of techniques used to parse a data structure include, but is not limited to, decoding part of or all of a data structure, decompressing part of or all of a data structure, reorganizing part of or all of a data structure, extracting out data from a data structure, and other techniques known in the art for parsing data structures. The data format module 106, according to an embodiment, is then configured to provide the parsed data structure to merged module 108 for analysis using similar techniques as described herein.

For an embodiment of system 102 illustrated in FIG. 1, a merge module 106 is coupled with a pack module 110. For an embodiment, upon merged module 108 generating a merged data structure, merged module 108 is configured to provide the merged data structure to a pack module 110. The pack module 110, according to an embodiment, is configured to receive the one or more merged data structures to generate a merged document based on the base document and all versions of the base document analyzed by the system 102. According to an embodiment, a pack module 110 includes a serialization component to save the one or more merged data structure as a file in the original format of the documents analyzed.

According to an embodiment, system 102 continues to analyze all the data structures in the base document and all versions of the base document to determine changes between the documents using one or more of the techniques described herein. Once the changes are determined, the pack module 110 is configured to generate a merged document based on the base document and all versions of the base document analyzed that incorporates all the changes between the documents. The iterative process of system 102 provides the benefit of maintaining the original format of the document if possible to prevent data loss. Further, the system 102 can use many techniques across different formats of documents alleviating the need to have a specialized technique for each format of document. For an embodiment, a pack module 110 is configured to provide the merged document to a communication interface 112. In turn, a communication interface 112 is configured to receive a merged document and to store the merged document in a database 114.

According to an embodiment communication interface module 112 is configured to receive and request one or more documents from one or more databases 114. In addition, an embodiment of a communication interface module 112 is configured to provide and to store one or more documents to one or more databases 114. An embodiment includes a communication interface 112 configured to access a document, for example, from a memory, a database, or an external server. Similarly, an embodiment includes a communication interface 112 configured to store a document, for example, in a memory, a database, or an external server. For an embodiment, system 102 is configured to compare and merge two or more documents. Another embodiment includes system 102 configured to compare and merge three or more documents. As such, one skilled in the art would understand the system and method described herein may be used to compare and merge any number of documents such as by using techniques described herein.

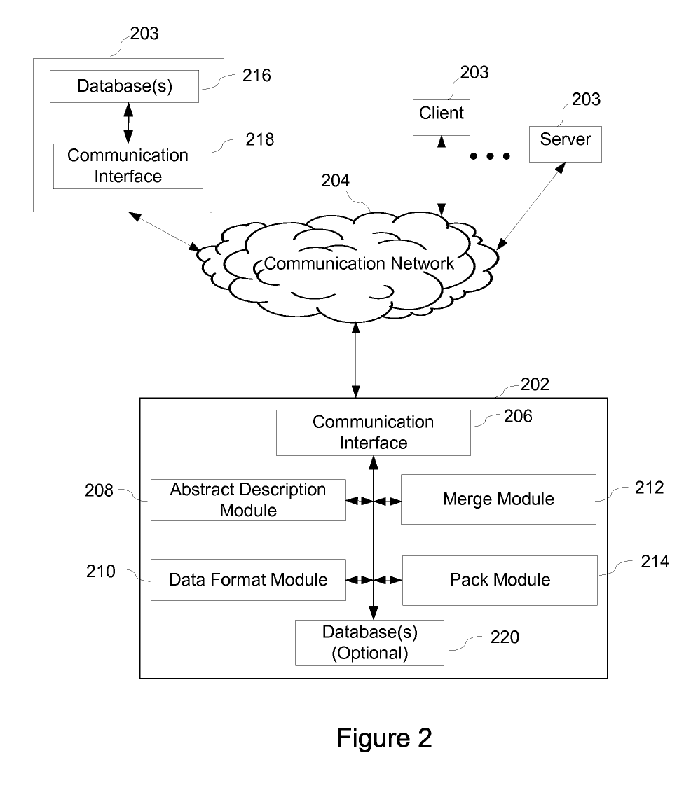

FIG. 2 illustrates a block diagram of a distributed system of an embodiment of a system 202 to compare and merge documents. For an embodiment system 202 may be configured to operate as a server in a client server relationship. For another embodiment system 202 may be configured to operate in a peer-to-peer relationship with one or more peers over a communication network 204. Yet another embodiment includes a system 202 coupled with one or more modules of the system over a communication network 204. A communication network 204 includes, but is not limited to, a wide area network (“WAN”), such as the Internet, a local area network (“LAN”), wireless network, or other type of network. According to embodiments, one or more devices 203 may be in communication with system 202 through a communication network 204. Devices 203 include, but are not limited to, a user device, a server, an external database, a peer, or other device that includes one or more modules configured to performing the compare or merge operations or receive results of the compare or merge operation.

According the embodiment of the system 202 illustrated in FIG. 2, an embodiment of a device 203 that includes one or more databases 216 coupled with a communication interface 218. A database 216 for an embodiment may be configured to store documents for comparing and may be configured to store merged documents, according to an embodiment. A communication interface 206, 218, according to an embodiment, is configured to manage communication through a communication network 204 using communication protocols. For some embodiments, communication interface 206 manages one or more communication sessions between a system 202 and one or more devices 203. A communication interface 206, 218 may also convert or package data or content information into the appropriate communication protocol depending on the protocol used by a device 203. According to some embodiments, a communication interface 206, 218 may be configured to use one or more communication protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other protocol.

The embodiment of system 202 as illustrated in FIG. 2, in addition to a communication interface 206, includes an abstract description module 208, a merge module 212, a data format module 210, a pack module 214 and optionally one or more databases 220. These modules are coupled with each other and configured to perform compare and merge operations such as using similar techniques as those described herein.

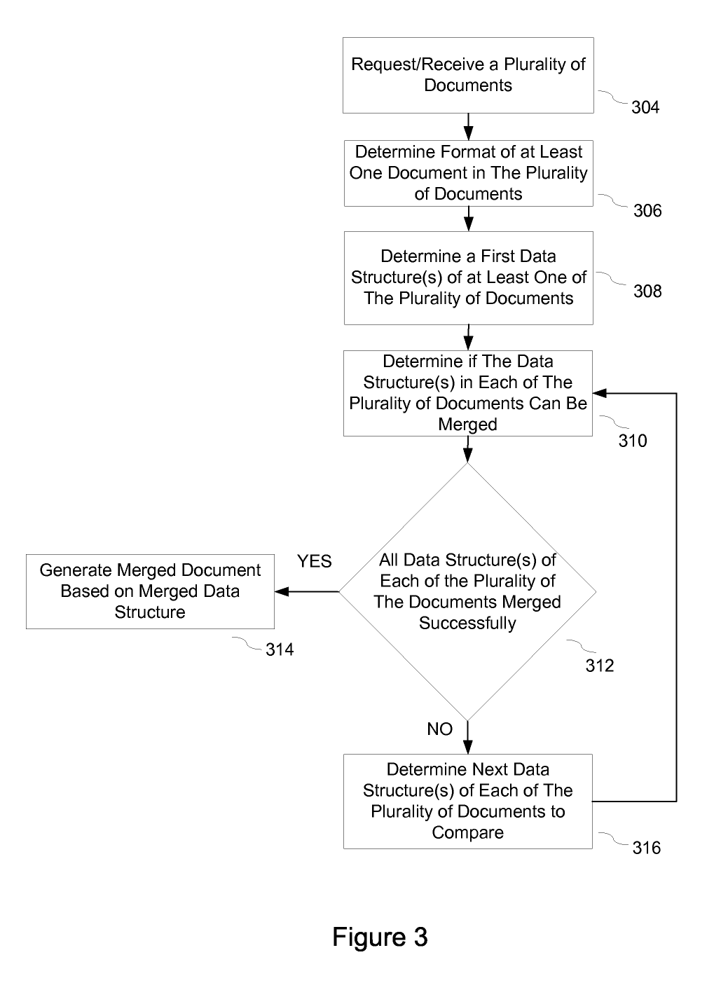

FIG. 3 illustrates a flow diagram for comparing and merging documents according to an embodiment. An embodiment of a method requests a plurality of documents to compare at block 304 such as using techniques as described herein. For another embodiment documents for comparing and merging documents, the method may include receiving the documents without a request. For some embodiments, the documents to compare include one or more data structures. The data structures may include one or more of text with formatting information, a data hierarchy, a data structure for each type of data, or another form of information with instructions on how it relates to the document as a whole. A document may include enterprise documents including those used for tasks including, but not limited to editing, presenting, arranging and collaborating on information in a format. For an embodiment, the method is configured to assume that all documents are of the same format, so the method determines a format for one document in the plurality of document received at block 306 such as by using techniques described herein. Another embodiment includes determining a format for each of documents in the plurality such as by using techniques described herein.

At block 308 the method includes determining a type of a first data structure of at least one of the plurality of documents using techniques described herein. For such an embodiment, the method may assume that the determined type of the first data structure is of the same type of a corresponding data structure found in some or all of the plurality of documents. For another embodiment, the method includes determining one or more data structures for each of the plurality of documents using techniques as described herein.

At block 310, the method determines if one or more of the data structures in the plurality of documents can be merged such as by using techniques described herein. For an embodiment, one of the plurality of documents is a base document or reference by which to determine differences in the rest of the plurality of documents. For such an embodiment, the resulting merged data structure includes changes in the plurality of documents from the base document such as by using techniques described herein. For an embodiment, determining if the data structures of each of the plurality of documents can be merged includes determining a merge case for one or more of the data structures such as by using techniques as described herein. According to an embodiment, the method determines if a collision occurred between one or more of the determined data structures when merging the documents according to a merge case such as by using techniques described herein. Upon a determination that all the data structures of each of the plurality of documents are merged successfully, the method at block 314 generates a merged document based on all merged data structures generated by the method such as by using techniques described herein. As discuss herein, the method generates a merged document that includes the changes over a base document based on the differences between the base document and the other of the plurality of documents analyzed.

If at block 312 the method determines that one or more documents includes one or more data structures that has not yet been merged because it has not been analyzed yet or because there is a collision, the method at block 316 determines one or more data structures of each of the plurality of documents to compare such as by using techniques discussed herein. As described above, if a collision arises the process may determine the next data structure type of a data structure included in the first data structure such as by using techniques described herein. If the process successfully merged the determined first data structures, the process may determine the next data structure included in at least one of the plurality of documents to be analyzed. The determination of the type of the next data structure is made at block 316 such as by using techniques as described herein. The process moves to block 310 to determine if the data structures that corresponding to one another in each of the plurality of documents can be merged such as by using techniques as described herein. According to the embodiment illustrated in the flow diagram in FIG. 3, the process continues through the iterations until all data structures are determined and successfully merged. As discussed above, the process at block 314 generates a merged document based on all the merged data structure such that the merged document incorporates all the changes between the plurality of documents.

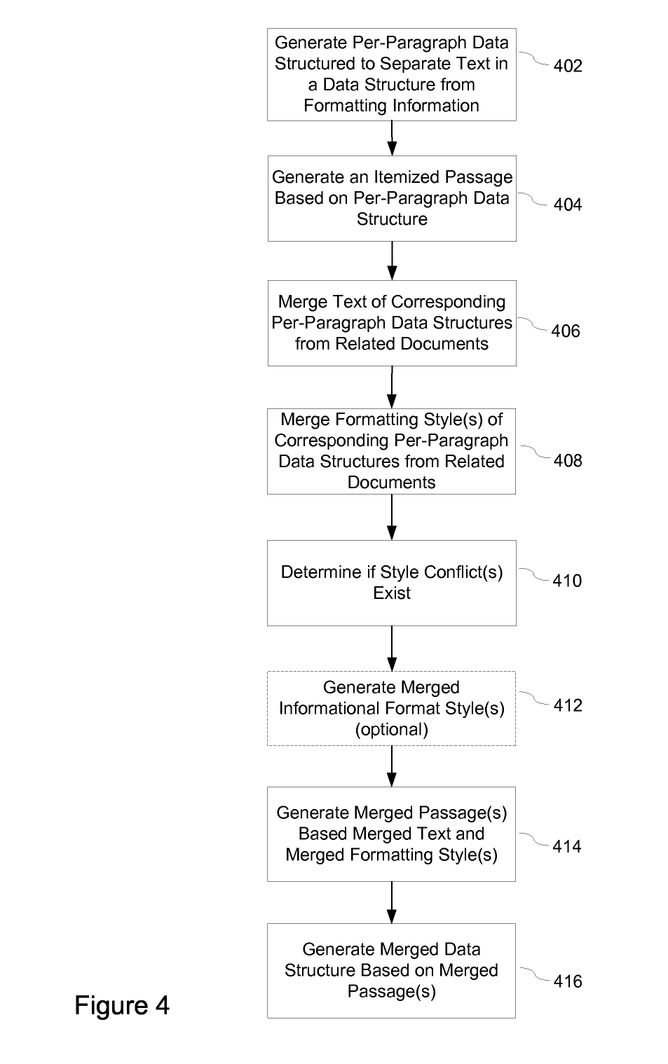

FIG. 4 illustrates a flow diagram for generating a merged data structure based on one or more data structures including formatted text according to an embodiment. For an embodiment, generating a merged data structured based on one or more data structures including formatted text from related documents may be performed as part of determining if a data structure in each of a plurality of documents can be merged using techniques including those described herein. For an embodiment, a merge module of a system such as those described herein is configured to generating a merged data structured based on one or more data structures including formatted text from related documents may be performed as part of determining if a data structure in each of a plurality of documents can be merged using techniques including those described herein.

A data structure including formatted text includes, but is not limited to, a multilayered text data structure. At block 402 in FIG. 4, a method generates a per-paragraph data structure to separate text in a data structure from formatting information included in the data structure. Formatting information may include a markup, a tag, an element, an object, an attribute, a class, a selector or other indication of format. Formatting information may be used to set or indicate a formatting style of text. A formatting style includes, but is not limited to, font, font size, color, emphasis such as boldface and italics, and semantic information such as a hyperlink, a comment, and a bookmark.

For an embodiment, a method generates a per-paragraph data structure for each paragraph contained in a data structure including formatted text. For an embodiment, a method generates a per-paragraph data structure that arranges text by formatting styles. A method, according to an embodiment, may generate a per-paragraph data structure that arranges text into one or more rows corresponding to a formatting style for that text. A per-paragraph data structure may include one or more run properties, which is a formatting style that applies to a sequence of text in a paragraph. A per-paragraph data structure may also include one or more paragraph properties, which is a formatting style that applies to all the text in a paragraph. For an embodiment, a passage includes one or more generated per-paragraph data structures. A format style layer, according to an embodiment, includes a sequence of text in a paragraph associated with its corresponding formatting style.

At block 404 illustrated in FIG. 4, a method generates an itemized passage based on a per-paragraph data structured. For an embodiment, a method generates an itemized passage by separating text from each paragraph by grammar parts based on a grammar part type. A grammar part type includes, but is not limited to, a character, a word, and a sentence. For an embodiment, punctuation and spaces are separate grammar parts in a word grammar part type. At block 406 as illustrated in FIG. 4, a method merges text or a grammar part of corresponding per-paragraph data structures from related documents. A method, according to an embodiment, merges text or a grammar part of corresponding per-paragraph data structured from related documents by comparing corresponding itemized passages from the related documents by grammar parts to determine differences between itemized passages. A method may determine differences between itemized passages and merge text or a grammar part by using techniques including, but not limited to a diff utility, script or program such as those known in the art, a three-way merge script, utility, or program such as those known in the art and other techniques described herein.

As illustrated in FIG. 4 at block 408, a method merges one or more formatting styles of corresponding per-paragraph data structures from related documents. For an embodiment, a method merges formatting styles of corresponding per-paragraph data structures from related documents by comparing the corresponding itemized passages based on a formatting style for each matching or corresponding grammar part. A method may determine a final formatting style by using techniques including, but not limited to, a three-way merge script, utility, or program such as those known in the art and other techniques described herein. A method determines if any formatting style conflicts exist, as illustrated in FIG. 4 at block 408. For an embodiment, a method determines that a formatting style conflicts if more than one formatting style is applied to the same portion of a matching grammar part based on rules. For example, a rule may indicate that a portion of a grammar part having formatting styles that include two different types of fonts is a conflict because two different fonts cannot be applied to the same portion of a grammar part. Other rules may set out formatting style conflicts based on font, font size, font color, semantic information or other formatting styles that cannot be applied simultaneously to the same portion of a grammar part. For an embodiment, if a method determines that a style conflict exists, the method generates one or more copies of the grammar part that has a formatting style conflict in an itemized passage so each conflicting formatting style can be separately applied to the corresponding grammar part.

At block 412, a method may optionally generate one or more informational formatting styles. An informational formatting style may indicate a type of change made including, but not limited to, unchanged, removed, inserted, and to indicate which document the change is originated from. For example, a method may generate one or more informational formatting styles to indicate an author of a document that resulted in a change from a base or reference document. For an embodiment, a method generates an informational formatting style by adding a row in a merged per-paragraph data structure that corresponds to a type of informational format style.

As illustrated in FIG. 4 at block 414, a method generates a merged passage based on one or more merged itemized passages and one or more formatting style layers from related documents using techniques for merging including those described herein. For an embodiment, a method may append a passage from a base document to include additions of one or more grammar parts and/or one or more formatting styles corresponding to one or more versions of the base document. Further, a method may delete one or more grammar parts and/or formatting styles from a base passage to reflect deletions or changes between a base document and one or more versions of the base document. A method, as illustrated in FIG. 4 at block 416, generates a merged data structure based on one or more merged passages using techniques including those described herein.

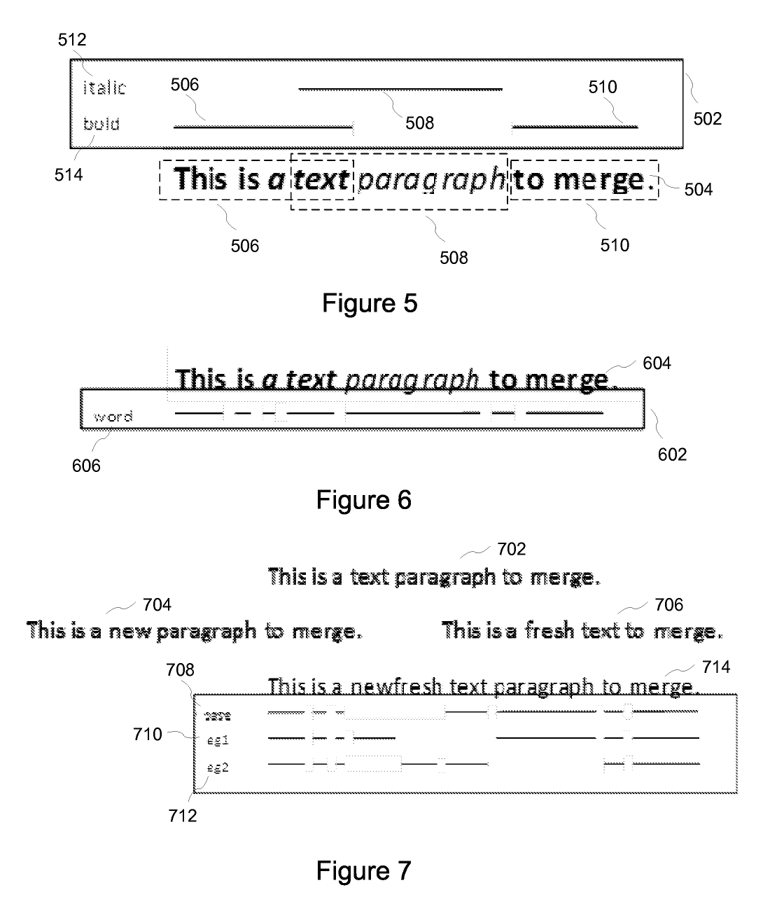

FIG. 5 illustrates a per-paragraph data structure according to an embodiment. The per-paragraph data structure 502 illustrated in FIG. 5 is a data structure generated based on a paragraph 504. According to an embodiment, a per-paragraph data structure 502 includes a row for at least each formatting style that is used in a paragraph 504. In an embodiment, each row for a formatting style forms a formatting style layer that includes one or more sequence of text having the same type of formatting style. According to the embodiment illustrated in FIG. 5, a per-paragraph data structure 502 includes a row for a first formatting style layer 512, labeled as italic, and a row for a second formatting style layer 514, labeled as bold. A per-paragraph data structure 502 includes a plurality of sequences of text from a paragraph and one or more formatting style layers each formatting style layer corresponding to a formatting style. According to the embodiment illustrated in FIG. 5, paragraph 504 includes a first sequence of text 506 that is included in the formatting style layer bold or boldface, a second sequence of text 508 that is included in the formatting style layer italics, and a third sequence of text 510 included in the formatting style layer bold. The first sequence of text 506 and the third sequence of text 504 are included in the per-paragraph data structure 502 illustrated in FIG. 5 in the row for the second formatting style layer 514 corresponding to bold. The second sequence of text 508 is included in the per-paragraph data structure 502 in the row for the first formatting style layer 514 corresponding to italics. According to an embodiment, if a text includes more than one formatting style, the text is arranged in all rows of formatting style layers used to represent the text. As illustrated in FIG. 5, “text” is included in the first sequence of text 506 and the second sequence of text 508 because “text” includes both the formatting styles layers of bold and italics. So, “text” is included in the first sequence of text 506 and included in the row for the second formatting style layer 514, corresponding to bold, and is included in the second sequence of text 508 and included in the italics formatting style layer. For an embodiment, a per-paragraph data structure 502 may include one or more rows of formatting style layers for a paragraph mark that indicates an end of a paragraph.

FIG. 6 illustrates an itemized passage according to an embodiment. An itemized passage 602 includes one or more grammar parts of a paragraph 604. According to the itemized passage 602 as illustrated in FIG. 6, the itemized passage 602 is represented as a sequence of grammar parts from type word. Thus, each word in paragraph 604 is included in the sequence of grammar parts 606 as illustrated in FIG. 6.

FIG. 7 illustrates a result generated by merging text of corresponding itemized passages from related documents according to an embodiment. FIG. 7 illustrates a first paragraph of a first document 702, such as a base document or an original version of a document, a first paragraph of a second document 704, such as a first leg (“leg1”) of the base document or a first version of the original version of the document, and a third paragraph of a third document 706, such as a second leg (“leg2”) or a second version of the original version of the original version of the document. A result 714, according to an embodiment, is generated as a result of performing a merge, such as using a three-way merge program, based on a first itemized passage 708 that corresponds to the first paragraph of a first document 702, a second itemized passage 710 that corresponds to the first paragraph of a second document 704, and a third itemized passage 712 that corresponds to the first paragraph of a third document 706, as illustrated in FIG. 7. Result 714 is generated based on grammar parts including in the itemized passages illustrated in FIG. 7 using merge techniques including those described herein. Thus, the result 714, as illustrated in FIG. 7, does not include formatting styles and illustrates an intermediary step of generating a merged data structure according to a method described herein.

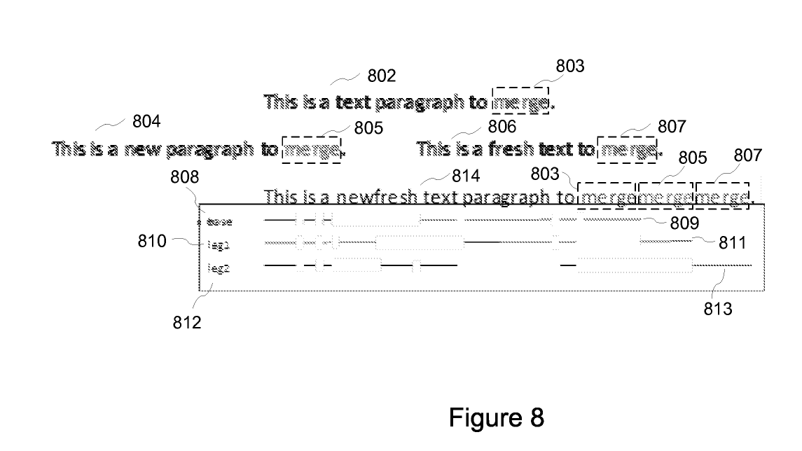

FIG. 8 illustrates a result generated by merging text and formatting styles from related documents according to an embodiment. FIG. 8 illustrates a first paragraph of a first document 802, such as a base document or an original version of a document, a first paragraph of a second document 804, such as a first leg (“leg1”) of the base document or a first version of the original version of the document, and a third paragraph of a third document 806, such as a second leg (“leg2”) or a second version of the original version of the original version of the document. A result 814, according to an embodiment, is generated based on a first paragraph of a first document 802 including a grammar part 803 having a formatting style that conflicts with a grammar part 805 in a first paragraph of a second document 804, and a grammar part 807 in a first paragraph of a third document 806.

As illustrated in FIG. 8, a result 814 is generated, according to an embodiment, based on a first itemized passage 808 that corresponds to the first paragraph of a first document 802 modified to include a first duplicate region 809 for the grammar part 803 that includes a formatting style that conflicts with a formatting style for the grammar part 805 and a formatting style for the grammar part 807. Result 814 is generated also based a second itemized passage 810 that corresponds to the first paragraph of a second document 804 modified to include a second duplicate region 811 for the grammar part 805 that includes a formatting style that conflicts with a formatting style for the grammar part 803 and a formatting style for the grammar part 807. In addition, result 814 is generated based on a third itemized passage 812 that corresponds to the first paragraph of a third document 806 modified to include a third duplicate region 813 for the grammar part 807 that includes a formatting style that conflicts with a formatting style for the grammar part 803 and a formatting style for the grammar part 805. Result 814 is generated based on grammar parts included in the itemized passages illustrated in FIG. 8 using merge techniques including those described herein. For an embodiment, a result 814 is generated using duplicate regions for applying formatting styles that cannot be applied to the same grammar part. Thus, a result 814 generated using techniques including those describe herein can be used as an intermediary step to generate a merged data structure based on per-paragraph data structures that include conflicts between one or more formatting styles.

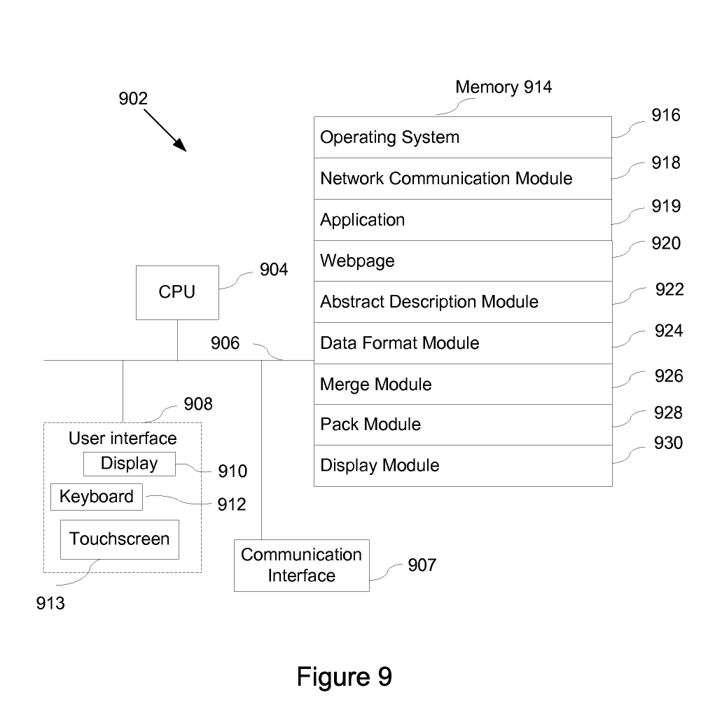

FIG. 9 illustrates an embodiment of system 902 that may be implemented as a client, server, a peer or other device that implements the methods described herein. The system 902, according to an embodiment, includes one or more processing units (CPUs) 904, one or more network or other communication interfaces 907, memory 914, and one or more communication buses 906 for interconnecting these components. The system 902 may optionally include a user interface 908 comprising a display device 910, a keyboard 912, touchscreen 913, and/or other input/output devices. Memory 914 may include high speed random access memory and may also include non-volatile memory, such as one or more magnetic or optical storage disks. The memory 914 may include mass storage that is remotely located from CPUs 904. Moreover, memory 914, or alternatively one or more storage devices (e.g., one or more nonvolatile storage devices) within memory 914, includes a computer readable storage medium. The memory 914 may store the following elements, or a subset or superset of such elements:

an operating system 916 that includes procedures for handling various basic system services and for performing hardware dependent tasks;

a network communication module 918 (or instructions) that is used for connecting the system 902 to other computers, clients, peers, systems or devices via the one or more communication network interfaces 907 and one or more communication networks, such as the Internet, other wide area networks, local area networks, metropolitan area networks, and other type of networks;

an application 919 including, but not limited to, a web browser, a document viewer or other application for viewing information;

a webpage 920 for indicating results, status of the method, or providing an interface for user feedback for the method as described herein;

an abstract description module 922 (or instructions) for generating a merge case based on a determined data structure as described herein;

a data format module 924 (or instructions) for determining the format of one or more documents, for parsing a document, and/or determining a data structure in a document as described herein;

a merge module 926 (or instructions) for merging data structures of one or more documents as described herein including determining a first data structure(s) of at least one of the plurality of documents can be merged;

a pack module 928 (or instructions) for receiving one or more merged data structures and generating a merged document based on the merged data structures as described herein; and

a display module 930 (or instructions) for transforming information from any of the modules into a format for viewing on a device as described herein.

Although FIG. 9 illustrates system 902 as a computer that could be a client and/or a server system, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 9 could be implemented on a single server or client and single items could be implemented by one or more servers or clients. The actual number of servers, client, or modules used to implement a system 902 and how features are allocated among them will vary from one implementation to another, and may depend in part on the amount of data traffic that the system must handle during peak usage periods as well as during average usage periods. In addition, some modules or functions of modules illustrated in FIG. 9 may be implemented on one or more one or more systems remotely located from other systems that implement other modules or functions of modules illustrated in FIG. 9.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system to compare and merge a plurality of documents comprising:
memory;
one or more processors; and
one or more modules stored in memory and configured for execution by the one or more processors, the modules comprising:
a data format module configured to determine a format of said base document and a first data structure in said base document, a second data structure in a first version of said base document, and a third data structure in a second version of said base document;
an abstract description module coupled with said data format module, said abstract description module configured to receive said determined first data structure, said determined second data structure and said determined third data structure, and said abstract description module configured to generate a merge case based on at least said first determined data structure;
a merge module coupled with said data format module and said abstract description module, said merged module configured to receive said determined first data structure, said determined second data structure, said determined third data structure and said merge case, said merged module to generate a merged data structure based on said determined first data structure, said determined second data structure, and said determined third data structure; and
a pack module coupled with said merge module, said pack module configured to receive said merged data structure and to generate a merged document based on at least said merged data structure.

2. The system of claim 1, wherein said data format module is further configured to determine if said base document includes a reference data structure.

3. The system of claim 1, wherein said data format module is configured to determine said format of said base document by determining if said base document includes a plurality of data structures.

4. A method for comparing and merging a plurality of documents comprising:
at one or more systems including one or more processors and memory:
determining a format of at least one document in a plurality of documents;
determining a first data structure of at least one of said plurality of documents;
determining if said first data structure can be merged with at least a second data structure of a second document in said plurality of documents;
in response to determining said first data structure can be merged with at least said second data structure, merging at least said first data structure and said second data structure to form a merged data structure;
generating a merged document based on at least said merged data structure.

5. The method of claim 4 further comprising:
determining if all data structures in each of said plurality of documents have been merged.

6. The method of claim 4 wherein determining if said first data structure can be merged with at least a second data structure includes generating a per-paragraph data structure.

7. The method of claim 6 wherein determining if said first data structure can be merged with at least a second data structure includes generating an itemized passage based on said per-paragraph data.

8. The method of claim 4 further comprising:
determining a third data structure of a third document of said plurality of documents; and
determining if said third data structure of said third document can be merged with said first data structure and said second data structure.

9. The method of claim 8 further merging at least said first data structure and said second data structure to form a merged data structure includes merging said first data structure, said second data structure, and said third data structure to form said merged data structure.

10. A method for comparing and merging a plurality of documents comprising:
at one or more systems including one or more processors and memory:
generating at least a first per-paragraph data structure based on a first data structure;
generating at least a second per-paragraph data structure based on said second data structure;
generating a first itemized passage based on said first per-paragraph data structure;
generating a second itemized passage based on said second per-paragraph data structure; and
generating a first merged passage based on at least said first itemized passage and said second itemized passage.

11. The method of claim 10 further comprising:
generating at least a third per-paragraph data structure based on a third data structure; and
generating a third itemized passage based on said third per-paragraph data structure and wherein, generating a first merged passage is based on said first itemized passage, said second itemized passage, and said third itemized passage.

12. The method of claim 10 wherein, said first per-paragraph data structure includes one or more format style layers that includes a sequence of text associated with a formatting style.

13. The method of claim 11 wherein, said one or more format style layers is a row for said formatting style in said first per-paragraph data structure.

14. The method of claim 10 wherein, said first itemized passage includes one or more grammar part types based on said first per-paragraph structured and said second itemized passage includes one or more grammar part types based on said second per-paragraph structure.

15. The method of claim 14 wherein, generating a first merged passage based on at least said first itemized passage and said second itemized passage includes merging said one or more grammar part types based on said first per-paragraph structure with said one or more grammar part types based on said second per-paragraph structure.

16. The method of claim 15 further comprises:
merging a first formatting style layer based on said first per-paragraph data structure with a second formatting style layer based on said second per-paragraph data structure by comparing a first row in said first per-paragraph data structure with a second row in said second per-paragraph data structure.

17. A system to compare and merge a plurality of documents comprising:
memory;
one or more processors; and
one or more modules stored in memory and configured for execution by the one or more processors, the modules comprising:
a merge module configured to:
receive at least a determined first data structure, a determined second data structure and a merge case,
generate at least a first per-paragraph data structure based on said determined first data structure,
generate at least a second per-paragraph data structure based on said determined second data structure,
generate a first itemized passage based on said determined first per-paragraph data structure,
generate a second itemized passage based on said determined second per-paragraph data structure,
generate a first merged passage based on at least said first itemized passage and said second itemized passage,
generate at least a first merged per-paragraph data structure based on at least said first merged passage, and
generate at least a first merged data structure based on at least said first merged per-paragraph data structure; and
a pack module coupled with said merge module, said pack module configured to receive said merged data structure and to generate a merged document based on at least said merged data structure.

18. The system of claim 17 wherein, said merge module is configured to:
generate at least a third per-paragraph data structure based on a determined third data structure; and
generate a third itemized passage based on said third per-paragraph data structure and wherein, generating a first merged passage is based on said first itemized passage, said second itemized passage, and said third itemized passage.

19. The system of claim 17 wherein, said first per-paragraph data structure includes one or more formatting style layers that include a sequence of text associated with a formatting style.

20. The system of claim 18 wherein, said one or more formatting style layers is a row for said formatting style in said first per-paragraph data structure.

21. The system of claim 17 wherein, said first itemized passage includes one or more grammar part types based on said first per-paragraph structured and said second itemized passage includes one or more grammar part types based on said second per-paragraph structure.

22. The system of claim 21 wherein, said merge module is configured to generate a first merged passage based on at least said first itemized passage and said second itemized passage by merging said one or more grammar part types based on said first per-paragraph structure with said one or more grammar part types based on said second per-paragraph structure.

23. The system of claim 22 wherein, said merge module is configured to:
merge a first formatting style based on said first per-paragraph data structure with a second formatting style based on said second per-paragraph data structure by comparing a first row in said first per-paragraph data structure with a second row in said second per-paragraph data structure.

24. A system to generate a merged document from a plurality of documents comprising:
memory;
one or more processors; and
one or more modules stored in memory and configured for execution by the one or more processors, the modules comprising:
a data format module configured to determine a format of said base document and a first data structure in said base document, a second data structure in said first version of said base document, and a third data structure in said second version of said base document;
an abstract description module coupled with said data format module, said abstract description module configured to receive said determined first data structure, said determined second data structure and said determined third data structure, and said abstract description module configured to generate a merge case based on at least said first determined data structure;
a merge module coupled with said data format module and said abstract description module, said merged module configured to receive said determined first data structure, said determined second data structure, said determined third data structure and said merge case, said merged module to generate a merged data structure based on said determined first data structure, said determined second data structure, and said determined third data structure; and
a pack module coupled with said merge module, said pack module configured to receive said merged data structure and to generate a merged document based on at least said merged data structure.
